(19) United States
(12) Patent Application Publication
(10) Pub. No.: US 2012/0229736 A1
(43) Pub. Date: Sep. 13, 2012

(54) LIQUID CRYSTAL PANEL AND LIQUID CRYSTAL DISPLAY DEVICE

(75) Inventors: Tomofumi Osaki, Osaka (JP); Taimi Oketani, Osaka (JP)

(73) Assignee: SHARP KABUSHIKI KAISHA, Osaka (JP)

(21) Appl. No.: 13/510,718

(22) PCT Filed: Oct. 7, 2010
(86) PCT No.: PCT/JP2010/067660

§ 371 Date: May 29, 2012

(30) Foreign Application Priority Data
Nov. 20, 2009 (JP) 2009-265295

(51) Int. Cl. G02F 1/1335; G02F 1/1339

(52) U.S. Cl. 349/96; 349/110; 349/190

(57) ABSTRACT

Disclosed is a liquid crystal panel that can prevent a light leakage from the outside through a sealing portion and that can achieve excellent display quality and a narrower frame. The liquid crystal panel 10 is provided with, in a non-display region 10B on a surface of a first substrate 11 on a side facing a second substrate 12, a black matrix installation area 30, which includes a black matrix forming section 32 and a black matrix non-forming section 34 that is enclosed by the black matrix forming section. A sealing portion 16 is formed in the black matrix installation area 30 such that a portion thereof that makes direct contact with the first substrate 11 is arranged in the black matrix non-forming section 34. On the side of the first substrate 11 that is opposite to the side facing the second substrate 12, a light-shielding member 52 that can block any light regardless of a polarization degree is disposed in a section that corresponds to the black matrix non-forming section 34 such that a part of the light-shielding member overlaps a black matrix 24 through the first substrate 11 interposed therebetween.

### TECHNICAL FIELD

The present invention relates to a liquid crystal panel and a liquid crystal display device equipped with the display panel. The present application claims priority to Japanese Application No. 2009-265295, filed in Japan on Nov. 20, 2009, which is hereby incorporated by reference in its entirety.

### BACKGROUND ART

In recent years, liquid crystal display devices equipped with liquid crystal display panels (liquid crystal panels) are widely used as image display devices (displays) for televisions, personal computers, and the like. Typically, such a liquid crystal panel is formed to be rectangular, and includes a pair of glass substrates (typically, an array substrate and a color filter (CF) substrate) bonded through a sealant with a prescribed spacing therebetween and a liquid crystal material sealed and held between the two substrates as a liquid crystal layer. The sealant is provided to seal the liquid crystal material between the substrates, and is formed in the peripheral portion of the glass substrates so as to enclose a typically rectangular active area (effective display region, i.e., a display screen region, which may also be simply referred to as a “display region” below), thereby constituting a sealing portion of the liquid crystal panel.

As the sealant that forms the sealing portion, ultraviolet curable resin materials that are cured when exposed to ultraviolet light are preferably used, for example. Typically, the glass substrates can be bonded and sealed by applying the sealant to one of the glass substrates along the peripheral portion thereof by a dispensing method, for example, by stacking the pair of glass substrates before curing the sealant, and by thereafter radiating ultraviolet light from a side of one of the stacked two glass substrates so as to cure the sealant.

In the display region of the CF substrate that constitutes the liquid crystal panel, an array of color filters of three colors: R (red); G (green); and B (blue), and a black matrix (light-shielding film) that borders the color filters (sub-pixels) of the respective colors (for preventing a light leakage between pixels, thereby improving the contrast, and for preventing the respective colors from being mixed) are formed. In the outer peripheral portion of the typically rectangular display region of the CF substrate, a black matrix for blocking undesired light that can enter the display region from the outside is formed in a peripheral frame (or border) shape so as to be extended from the black matrix of the display region. Thus, the display region and a non-display region that is formed so as to enclose the display region in the liquid crystal display device (liquid crystal panel) are divided by the frame-shaped black matrix (may also be referred to as a “frame black matrix” below).

When a pair of glass substrates are bonded to each other by radiating ultraviolet light to a sealant made of an ultraviolet curable resin material in manufacturing a liquid crystal panel that includes the frame black matrix described above, the following problem occurred owing to a characteristic of the frame black matrix that does not allow ultraviolet light to pass through (or it is difficult for ultraviolet light to pass through). The problem will be explained with reference to figures. FIG. 8 is a schematic view showing a cross-sectional structure of a non-display region 210B of a liquid crystal panel 210. FIG. 9 is a schematic view showing a cross-sectional structure of a non-display region 310B of a liquid crystal panel 310 that is another typical example.

As shown in FIG. 8, a method for curing a sealant sandwiched between a pair of glass substrates (array substrate and CF substrate) that constitute a liquid crystal panel by radiating ultraviolet light typically includes applying a sealant (216) on the outer peripheral side (outer side) of a frame black matrix 224, and radiating ultraviolet light (UV light) to a portion where the sealant (216) is provided from a surface of a CF substrate 211 on the side opposite to the side facing an array substrate 212, for example. With this method, the sealant (216) that is disposed so as to avoid the frame black matrix 224 can be cured in a desired manner, and a sealing portion 216 can therefore be formed. However, because the sealing portion 216 is formed outside of the frame black matrix 224, which is formed outside of the display region of the liquid crystal panel 210, the frame-shaped non-display region 210B that surrounds the display region 210A becomes larger. The liquid crystal panel 210 having this configuration cannot be suitably used for recent liquid crystal display devices that are increasingly having larger display screens (i.e., increasing an area of the display region 210A) and narrower frames (i.e., reducing an area of the non-display region 210B (making the frame-shaped non-display region 210B narrower)).

On the other hand, another example of a method of radiating ultraviolet light to a sealant sandwiched by a pair of glass substrates that constitute a liquid crystal panel is described in Patent Document 1. That is, Patent Document 1 discloses a method of disposing a sealant (316) on a frame black matrix 324, and radiating ultraviolet light (UV light) to a portion where the sealant (316) is provided from a surface of an array substrate 312 on the side opposite to the side facing a CF substrate 311, as shown in FIG. 9. In this method, because a sealing portion 316 is formed on the frame black matrix 324, a frame-shaped non-display region 310B that surrounds a display region 310A of a liquid crystal panel 310 can be made smaller, thereby achieving a narrower frame as compared with the liquid crystal panel 210 configured in the above-mentioned manner. However, in order to cure the sealant (316) by radiating ultraviolet light from the side of the array substrate 312, it is necessary to provide a slit in not-shown metal wiring lines (source lines and gate lines, for example) that are formed in the array substrate 312 and that are led out to an end portion (end portion to which a not-shown printed board and the like are connected) of the array substrate 312 so as to allow ultraviolet light to reach the sealant (316) through the slit. When ultraviolet light is radiated in this manner, the ultraviolet light cannot be uniformly radiated across the portion where the sealant (316) is disposed, and this uneven irradiation causes some parts to be poorly cured, resulting in a problem of the sealant (316) not being cured properly.

In a liquid crystal panel disclosed in Patent Document 2, a light-shielding member is provided on a rear surface of the substrate, covering an area from the peripheral edge to a sealing portion so as to block light emitted from a backlight disposed on a rear side of an array substrate. Patent Document 3 discloses a method of providing a transmissive region in a black matrix in a CF substrate, and curing a sealant by radiating light through the transmissive region.

### RELATED ART DOCUMENTS

### Patent Documents

Patent Document 1: Japanese Patent Application Laid-Open Publication No. H11-52394
Patent Document 2: Japanese Patent Application Laid-Open Publication No. H9-211473
Patent Document 3: Japanese Patent Application Laid-Open Publication No. 2004-62138

### SUMMARY OF THE INVENTION

### Problems to be Solved by the Invention

However, these conventional technologies have not yet reached a level where the following effects are simultaneously achieved at a high level so as to provide a liquid crystal panel that has excellent display quality and a narrower frame: forming a sealing portion with an excellent sealing property by curing a sealant made of a photocurable resin (typically, an ultraviolet curable resin) in a desired manner through appropriately radiating light (typically, ultraviolet light); and preventing external light from leaking into the liquid crystal panel through the sealing portion.

The present invention was made from this point of view, and a main object of the present invention is to provide a liquid crystal panel that can achieve excellent display quality and a narrower frame by forming a sealing portion (typically, by curing a sealant with radiation of light) that seals a liquid crystal layer with an excellent sealing property, and by preventing external light from entering through the sealing portion. Another object of the present invention is to provide a liquid crystal display device equipped with such a liquid crystal panel. Yet another object of the present invention is to provide a method for manufacturing such a liquid crystal panel.

### Means for Solving the Problems

In order to solve the above-mentioned problems, a liquid crystal panel provided by the present invention includes: first and second substrates facing each other; a liquid crystal layer disposed between the two substrates; and a sealing portion formed in a peripheral portion between the substrates so as to enclose the liquid crystal layer, the sealing portion holding the liquid crystal layer between the two substrates. In the liquid crystal panel, the sealing portion is provided on a surface of the first substrate on a side facing the second substrate in a non-display region, which is formed in an outer periphery of a display region, such that at least part thereof makes direct contact with the first substrate. The non-display region is provided with a black matrix installation area that includes a black matrix forming section and a black matrix non-forming section enclosed by the black matrix forming section. In the black matrix forming section, a black matrix that blocks external light from entering the display region is formed. The black matrix non-forming section enclosed by the black matrix forming section does not have the black matrix formed therein. The sealing portion is formed in the black matrix installation area such that the part thereof making direct contact with the first substrate is at least partially located in the black matrix non-forming section.

The first substrate has a light-shielding member on a surface thereof on a side opposite to the surface facing the second substrate. The light-shielding member is formed in a section that corresponds to the black matrix non-forming section such that a part thereof overlaps the black matrix through the first substrate interposed therebetween, and the light-shielding member is made of a material that can block the external light regardless of a degree of polarization thereof.

The “non-display region, which is formed in an outer periphery of a display region” used herein refers to a region located outside of an effective display region where an image is displayed to an observer (viewer), that is, a region that encloses an active area (pixel matrix).

In the black matrix installation area in the non-display region of the liquid crystal panel according to the present invention, at least a part of the sealing portion makes direct contact with the first substrate, and the part making direct contact is partially located in the black matrix non-forming section. This means that external light could enter the display region through the black matrix non-forming section. However, the liquid crystal panel according to the present invention is provided with the light-shielding member on the surface of the first substrate on the side opposite to the side facing the second substrate. The light-shielding member overlaps the black matrix through the first substrate interposed therebetween, thereby covering the black matrix non-forming section. The light-shielding member is capable of blocking any external light regardless of the degree of polarization. By having this light-shielding member, any external light that could enter through the black matrix non-forming section can be blocked regardless of the degree of polarization.

According to the liquid crystal panel of the present invention, by providing the sealing portion in the black matrix installation area, the non-display region can be made smaller, thereby achieving a narrower frame. Also, according to the liquid crystal panel, any external light that could enter the display region of the panel can be appropriately blocked regardless of the degree of polarization. This makes it possible to achieve the liquid crystal panel with excellent display quality that can appropriately prevent light from leaking into the display region through the sealing portion (the above-mentioned black matrix non-forming section) and that can be employed for both the normally black type and the normally white type. Thus, with the liquid crystal panel according to the present invention, it becomes possible to provide a liquid crystal panel that can achieve both the narrower frame and the excellent display quality. Further, according to such a liquid crystal panel, because at least a part of the sealing portion makes direct contact with the first substrate, the adhesion strength of the sealing portion can be increased as compared with a case where the sealing portion makes contact with the black matrix.

In a preferred embodiment of the liquid crystal panel disclosed herein, the sealing portion is made of a photocurable resin material.

In such a liquid crystal panel, by using the photocurable resin material for the sealing portion, even when light for curing the material (ultraviolet light, for example) is radiated from a side of the first substrate opposite to the side facing the second substrate, the light can enter a space between the substrates through the black matrix non-forming section, and therefore can cure the sealant disposed between the substrates properly with ease, thereby allowing the substrate and the sealing portion (sealant) to be bonded (adhered) firmly. Therefore, with the liquid crystal panel having configured in the manner described above, it becomes possible to provide a liquid crystal panel that has a strong (that is, properly cured) and highly adhesive sealing portion, which can securely seal the liquid crystal layer between the substrates for a long period of time, making possible excellent durability.

In a preferred embodiment of the liquid crystal panel disclosed herein, the light-shielding member is a tape-shaped or a film-shaped member.

In such a liquid crystal panel, the black matrix non-forming section can be covered with the above-mentioned light-shielding member effectively with ease. A light leakage to the display region through the sealing portion can therefore be appropriately prevented, which makes it possible to provide a liquid crystal panel with excellent display quality.

In a preferred embodiment of the liquid crystal panel disclosed herein, the black matrix non-forming section is formed as a slit having a prescribed width.

The liquid crystal panel having such a configuration is preferred because a slit can be formed with ease as the black matrix non-forming section and an area of the black matrix non-forming section that is to be closed (covered) with the light-shielding member can be minimized. Forming the slit as the black matrix non-forming section is also preferable in achieving the above-mentioned effect (allowing the sealant made of a photocurable resin material to be properly cured to form the sealing portion, for example) in a desired manner.

In another preferred embodiment of the liquid crystal panel disclosed herein, the polarizing sheet is disposed on the surface of the first substrate on the side opposite to the side facing the second substrate. The polarizing sheet is arranged such that a center portion thereof covers the display region and such that a peripheral portion thereof overlaps a part of the non-display region. The light-shielding member is provided such that at least a part thereof overlaps the peripheral portion of the polarizing sheet.

In such a liquid crystal panel, the polarizing sheet is disposed on the surface of the first substrate on the side opposite to the side facing the second substrate, and the light-shielding member is arranged so as to overlap the polarizing sheet having no gap therebetween. Thus, according to the liquid crystal panel having this configuration, external light that could enter the display region through a gap between the light-shielding member and the polarizing sheet can also be effectively blocked, thereby achieving a liquid crystal panel with excellent display quality.

In another aspect of the present invention, a method for manufacturing a liquid crystal panel is provided. That is, the present invention provides a manufacturing method for a liquid crystal panel that includes a pair of substrates facing each other, a liquid crystal layer disposed between the pair of substrates, and a sealing portion formed in a peripheral portion between the pair of substrates so as to enclose the liquid crystal layer, the sealing portion holding the liquid crystal layer between the pair of substrates. The method includes the following steps (1) to (5). That is, the method includes (1) preparing first and second substrates that constitute the pair of substrates, wherein the first substrate has a black matrix installation area that includes a black matrix forming section and a black matrix non-forming section on one surface side in a non-display region formed in an outer periphery of a display region, the black matrix forming section has therein a black matrix that blocks external light from entering the display region, and the black matrix non-forming section does not have the black matrix and is enclosed by the black matrix forming section, (2) applying a sealant that forms the sealing portion such that at least a part thereof makes direct contact with the first substrate, the sealant being provided in the black matrix installation area such that that part thereof making direct contact with the first substrate is at least partially located in the black matrix non-forming section, (3) assembling the first substrate and the second substrate having the sealant interposed therebetween such that a surface of the first substrate where the black matrix is formed faces the second substrate, (4) curing the sealant to form a sealing portion that bonds the first substrate and the second substrate through the sealing portion, and (5) disposing a light-shielding member on an surface of the first substrate on the side opposite to the surface facing the second substrate in a section that corresponds to the black matrix non-forming section, such that a part of the light-shielding member overlaps the black matrix through the first substrate interposed therebetween, the light-shielding member being made of a material that can block the external light regardless of a degree of polarization thereof.

By employing the method for manufacturing a liquid crystal panel according to the present invention, the sealing portion can be disposed in the black matrix installation area, which makes it possible to provide a liquid crystal panel with a smaller non-display region and hence a narrower frame. Also, by employing the above-mentioned method, any external light that could enter the display region can be appropriately blocked regardless of the degree of polarization. This makes it possible to provide a liquid crystal panel that can prevent light from entering the display region through the sealing portion and that therefore has excellent display quality. Thus, by employing the method according to the present invention, it becomes possible to manufacture a desired liquid crystal panel that can achieve both the narrower frame and the excellent display quality.

In a preferred embodiment of the manufacturing method disclosed herein, a sealant made of a photocurable resin material is used as the sealant, and the sealant is cured by light that is radiated from a side of the first substrate opposite to the side facing the second substrate so as to pass through the black matrix non-forming section.

In the manufacturing method having this configuration, by employing a photocurable resin material as the sealant, it becomes possible to cure the sealant by radiating light (ultraviolet light, for example) from the side of the first substrate that is opposite to the side facing the second substrate such that the light enters a space between the substrates through the black matrix non-forming section. Therefore, by employing the manufacturing method having the above-mentioned configuration, it becomes possible to properly cure the sealant disposed between the two substrates with ease, and make it in direct contact with the first substrate. It also becomes possible to provide a high-durability liquid crystal panel having a properly-cured and strong sealing portion that can securely seal a liquid crystal layer with a strong adhesion.

In a preferred embodiment of the liquid crystal panel disclosed herein, the light-shielding member is a tape-shaped or film-shaped light-shielding member, and is attached to the surface of the first substrate on the side opposite to the side facing the second substrate.

In the manufacturing method having this configuration, by employing such a light-shielding member, the light-shielding member can be provided on the first substrate to cover the black matrix non-forming section with ease. Thus, by employing the manufacturing method having the configuration, it becomes possible to provide a desired liquid crystal panel that can prevent light from entering through the sealing portion.

In another preferred embodiment of the manufacturing method disclosed herein, a substrate where a slit of a prescribed width is formed as the black matrix non-forming section is used as the first substrate.

By employing the manufacturing method with this configuration, it becomes possible to provide a slit as the black matrix non-forming section with ease. In covering such a black matrix non-forming section with the light-shielding member, an area of the black matrix non-forming section that needs to be covered can be minimized, reducing the amount used of the light-shielding member and an area of the light-shielding member (an area of a region where the light-shielding member is attached) on the first substrate.

In yet another preferred embodiment, the manufacturing method disclosed herein further includes placing a polarizing sheet on the surface of the first substrate on the side opposite to the side facing the second substrate such that a center portion thereof covers the display region and such that a peripheral portion thereof overlaps a part of the non-display region, and after the polarizing sheet is provided, the light-shielding member is placed such that at least a part thereof overlaps the peripheral portion of the polarizing sheet.

By employing the manufacturing method with the configuration, the light-shielding member and the polarizing sheet can be disposed so as to overlap each other having no gap therebetween. This makes it possible to effectively block external light that could enter the display region through a gap between the light-shielding member and the polarizing sheet, thereby providing a liquid crystal panel with high display quality.

In any one of the liquid crystal panels disclosed herein and in a liquid crystal panel manufactured by any one of the manufacturing methods disclosed herein, a frame can be made narrower, and a possible light leakage to a display region can be appropriately prevented as described above. Also, because the liquid crystal panel is provided with a sealing portion that is properly cured and that is attached to the substrate firmly, the liquid crystal layer can be securely sealed for a long period of time, which can result in high durability. Thus, by employing this liquid crystal panel for a liquid crystal display device, it becomes possible to provide a high-durability liquid crystal display device that can achieve both a narrower frame and an excellent display quality at a high level.

### BRIEF DESCRIPTION OF THE DRAWINGS

FIG. 1 is a cross-sectional view schematically showing a configuration of a liquid crystal display device according to one embodiment.

FIG. 2 is a plan view schematically showing a principal part of a liquid crystal panel according to one embodiment.

FIG. 3 is a cross-sectional view along the line III-III in FIG. 2 schematically showing a structure of the liquid crystal panel.

FIG. 4 is a cross-sectional view along the line IV-IV in FIG. 2 schematically showing a peripheral portion of the liquid crystal panel.

FIG. 5 is a schematic diagram showing a cross-sectional structure of a non-display region of a liquid crystal panel that is configured to have a slit as a black matrix non-forming section.

FIG. 6 is a schematic diagram showing a cross-sectional structure of a non-display region of a liquid crystal panel configured to have a polarizing plate.

FIG. 7 is a schematic cross-sectional view showing a non-display region of a liquid crystal panel when light is radiated so as to cure a sealant.

FIG. 8 is a schematic diagram showing a cross-sectional structure of a non-display region of a liquid crystal panel that has a conventional configuration.

FIG. 9 is a schematic diagram showing a cross-sectional structure of a non-display region of a liquid crystal panel that has another conventional configuration.

### DETAILED DESCRIPTION OF EMBODIMENTS

Preferred embodiments of the present invention will be explained below with reference to figures. Matters not specifically mentioned herein, but necessary to implement the present invention (a configuration of the liquid crystal display device other than the liquid crystal panel, a construction method of the device, and the like, for example) can be worked out as design matters by those skilled in the art based on conventional technologies in the field. The present invention can be implemented based on the contents disclosed herein and common technical knowledge in the field.

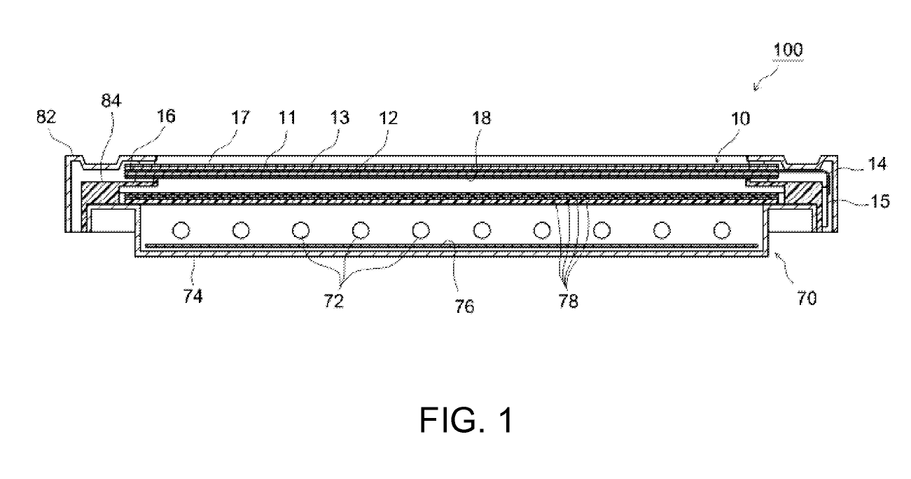

Below, with reference to FIGS. 1 to 7, a liquid crystal panel according to a preferred embodiment of the present invention, a liquid crystal display device equipped with such a panel, and a method for manufacturing the liquid crystal display device will be explained using an active matrix type (TFT type) liquid crystal display device 100 as an example. In the following figures, the same reference characters are given to members and portions that have the same functions, and duplicative explanations may be omitted or abridged. Also, the dimensional relationship (length, width, thickness, and the like) in each of the figures does not necessarily reflect the actual dimensional relationship accurately. In the description below, “front surface” or “front side” refers to the side facing a viewer (observer) of the liquid crystal display device 100 (that is, the liquid crystal panel side), and “rear surface” or “backside” refers to the side not facing the viewer of the liquid crystal display device 100 (that is, the backlight device side).

An overall configuration of the liquid crystal display device 100 will be explained with reference to FIG. 1. As shown in FIG. 1, the liquid crystal display device 100 includes a liquid crystal panel 10, and a backlight device 70, which is an external light source disposed on the rear surface side (bottom side in FIG. 1) of the liquid crystal panel 10. The liquid crystal panel 10 and the backlight device 70 are assembled together by a bezel (frame body) 82 and the like, and are thereby held in a unified manner.

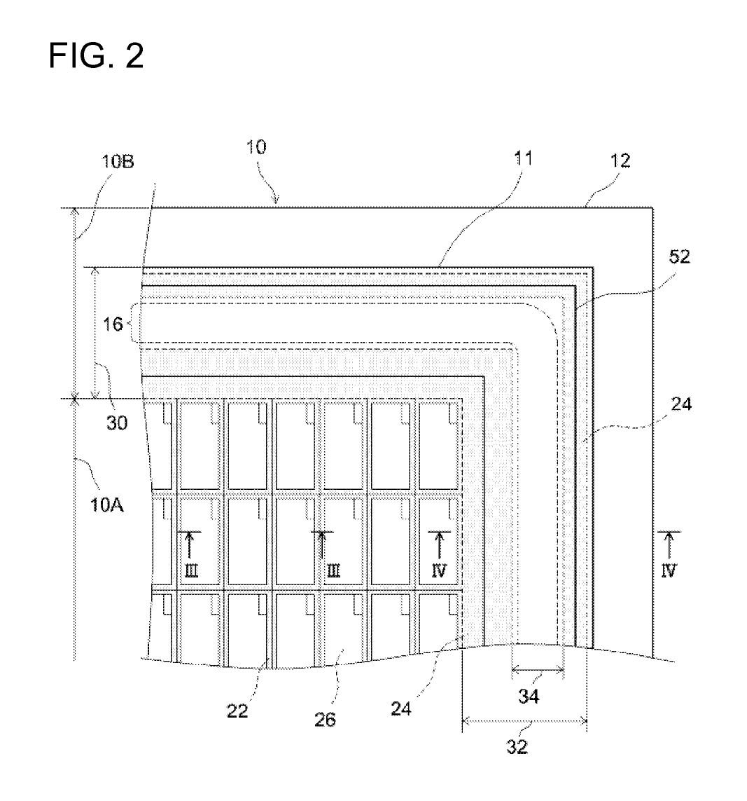

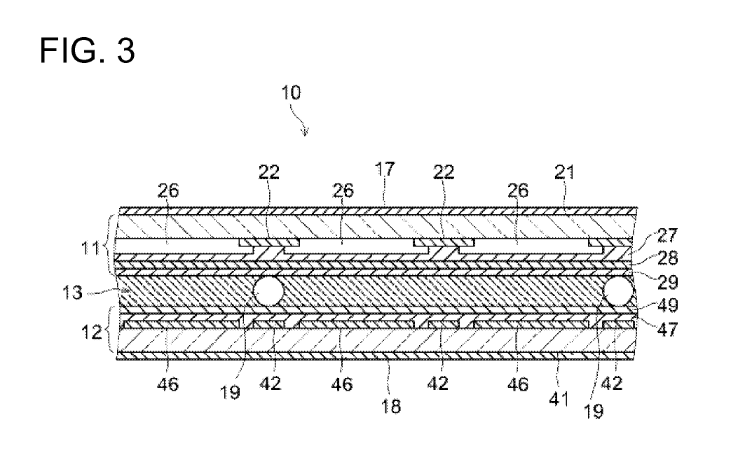

A configuration of the liquid crystal panel 10 will be explained with reference to FIGS. 2 and 3.

As shown in FIG. 2, the liquid crystal panel 10 is formed in a substantially rectangular shape as a whole. The panel 10 has a display region 10A and a non-display region 10B. The display region 10A is a (typically rectangular) region having pixels in the center region thereof, and displays images to a viewer. The (typically border-shaped or frame-shaped) non-display region 10B is formed in the outer peripheral portion of the display region 10A so as to enclose the display region 10A, and does not display images.

As shown in FIG. 3, this liquid crystal panel 10 has a sandwich structure made of a pair of transparent glass substrates 11 and 12 that are facing each other, and a liquid crystal layer 13 sealed therebetween. Of the pair of substrates 11 and 12, one on the front surface side is a color filter substrate (CF substrate) 11, and the other on the rear surface side is an array substrate (TFT substrate) 12.

In the non-display region 10B, a sealing portion 16 is formed on the peripheral portion of the glass substrates 11 and 12 so as to enclose the display region 10A, thereby sealing the liquid crystal layer 13. At least a part of the sealing portion 16 makes direct contact with the CF substrate 11 (to be exact, with a transparent electrode 28 formed on a glass substrate 21 in a manner described below). It is preferable that the sealing portion 16 be also directly placed on the array substrate 12 (to be exact, on a planarizing layer (or interlayer insulating film) 47 formed on a glass substrate 41).

The liquid crystal layer 13 is made of a liquid crystal material that includes liquid crystal molecules. The optical characteristics of the liquid crystal material are changed in accordance with the electrical field applied across the glass substrates 11 and 12, which controls the orientation of the liquid crystal molecules.

On respective surfaces of the glass substrates 11 and 12 on the sides facing each other (inner sides), alignment films 29 and 49 that determine the orientation directions of the liquid crystal molecules are formed.

The array substrate 12 and the CF substrate 11 of the liquid crystal panel 10 disclosed herein are explained in detail. The two glass substrates 11 and 12 are configured in a manner similar to a typical liquid crystal panel, except for a configuration near the sealing portion 16 provided in the non-display region 10B, which will be later described. Below, the array substrate 12 and the CF substrate 11 in the display region 10A will be described, respectively.

On the front surface side (that is, the side facing the CF substrate 11, and the side adjacent to the liquid crystal layer 13) of the array substrate 12, an array of pixels (specifically, sub-pixels), each of which is the smallest unit for displaying an image, is formed in the display region 10A. In the display region 10A, a plurality of source lines 42 and a plurality of not-shown gate lines for driving the respective pixels (sub-pixels) are also arranged so as to form a grid pattern. In the respective grid regions that are enclosed by the source lines 42 and the gate lines, not-shown switching elements (thin film transistors (TFTs), for example) and pixel electrodes 46 are respectively provided. Through the source lines 42 and the switching elements, voltages that correspond to an image are applied to the pixel electrodes 46 at a prescribed timing.

As shown in FIG. 1, a plurality of flexible boards (TCPs) 14 are attached side by side to at least one side of the periphery of the rectangular array substrate 12. Not-shown liquid crystal panel driving IC chips (driver IC chips) for driving the liquid crystal panel 10 are mounted on the respective flexible boards 14, and are connected to the source lines 42 and the gate lines. A connecting board 15 having a controller for the driver IC (chip), other electronic components, and the like built therein is attached to the end of the flexible board 14. The connecting board 15, which is also referred to as a printed board (PCB), is arranged in a side surface portion of the backlight device 70 (to be exact, a side surface portion of a frame 84 on the outer periphery side), or on the backside of the backlight device 70 by the flexible board 14 being folded toward the backlight device 70.

The pixel electrodes 46, the source lines 42, and the gate lines are covered with the planarizing layer (also referred to as an interlayer insulating film) 47 made of an insulating material. On the planarizing layer 47, the alignment film 49 made of polyimide or the like is formed as described above. An alignment treatment (rubbing treatment, for example) may be performed to the surface of the alignment film 49 so as to control the orientation direction of the liquid crystal molecules when no voltage is applied.

On the other hand, as shown in FIG. 3, the CF substrate 11 includes color filters 26 of R (red), G (green), and B (blue), each of which faces one pixel electrode 46 in the array substrate 12, a black matrix 22 that borders the color filters 26 of the respective colors, and a common electrode (transparent electrode) 28 that is uniformly formed on the surfaces of the color filters 26 and the black matrix 22 in the display region 10A. The black matrix 22 is made of a metal such as Cr (chrome) so as to block light from passing through regions between the respective sub-pixels.

As shown in FIG. 3, the planarizing layer 27 is formed so as to cover the color filters 26 and the black matrix 22, and on the surface of the planarizing layer 27, the transparent electrode (common electrode) 28 made of ITO is formed. Further, on the surface of the transparent electrode 28, the alignment film 29 is formed. The alignment treatment may also be performed to the surface of the alignment film 29. The alignment direction of the alignment film 49 of the array substrate 12 and the alignment direction of the alignment film 29 of the CF substrate 12 are made to differ from each other by 90°.

As shown in FIG. 3, a plurality of spherical or columnar spacers 19 (spherical in FIG. 3) are randomly disposed so as to be sandwiched between the array substrate 12 and the CF substrate 11. The spacers 19 are formed of a resin material that can be elastically deformed, for example. This way, the gap (spacing) between the substrates 11 and 12 is maintained by the sealing portion 16 and the spacers 19, thereby ensuring a constant thickness of the liquid crystal layer 13.

Polarizing sheets (polarizing plates) are typically provided on the surfaces of the substrates 11 and 12 on the sides that are not facing each other. In this embodiment, as shown in FIG. 3, polarizing sheets 17 and 18 are respectively bonded to the glass substrates 11 and 12. In a so-called normally white liquid crystal display device, the two polarizing sheets 17 and 18 are disposed such that the polarizing axes thereof cross at right angle. In a so-called normally black liquid crystal display device, the two polarizing sheets 17 and 18 are disposed such that the polarizing axes thereof become parallel with each other.

A configuration of the above-mentioned pixels, a configuration of electrodes such as wiring lines, driver circuits, and the like may be similar to those of a conventional liquid crystal panel, and because the present invention is not defined by them, the detailed explanations are omitted.

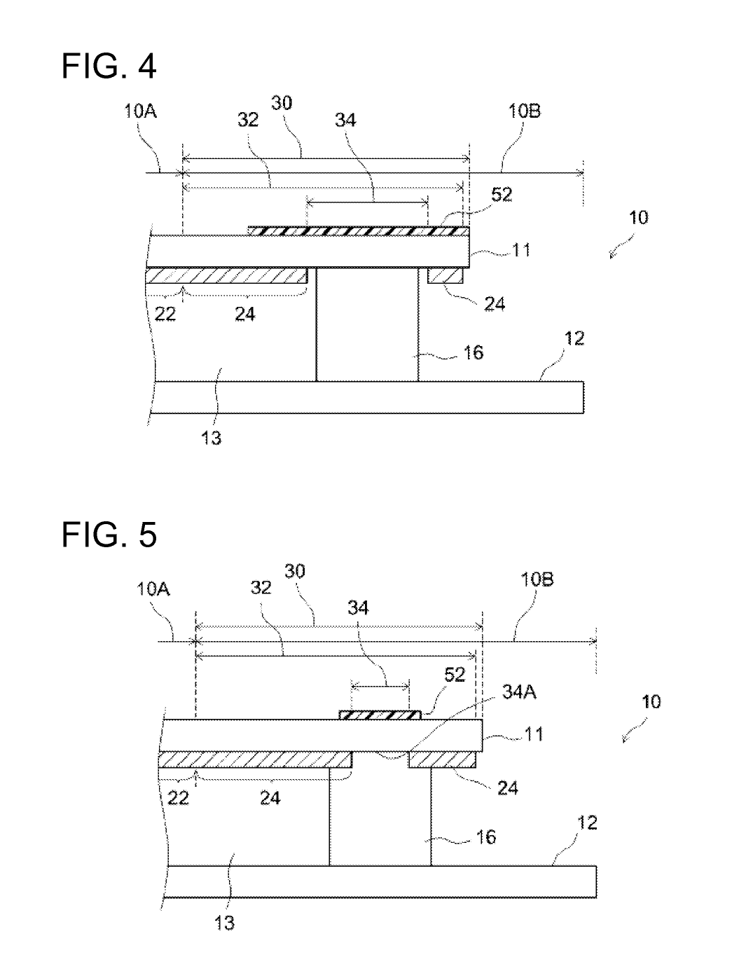

A configuration of the non-display region 10B in the liquid crystal panel 10 of this embodiment having the above-mentioned configuration will be explained with reference to FIG. 2, and FIGS. 4 to 6. In FIGS. 4 to 6, parts and members disposed on the CF substrate 11 other than the black matrix 22 and a frame black matrix 24 (the planarizing layer 27, the transparent electrode 28, the alignment film 29, and the like, for example) are not shown for simplification. Similarly, the pixel electrodes 46, metal wiring lines (source lines 42 and gate lines), the planarizing layer 47, and the like that are disposed on the array substrate 12 are not shown in the figures for simplification.

As shown in FIGS. 2 and 4, in the non-display region 10B of the liquid crystal panel 10, the sealing portion 16 is formed between the two substrates 11 and 12 of the liquid crystal panel 10 so as to seal the liquid crystal layer 13 held between these substrates. As described above, at least a part of the sealing portion 16 is in direct contact with (typically affixed to) the CF substrate 11 (and preferably with the array substrate 12). The sealing portion 16 can be suitably formed by using a sealant made of a material that is capable of being affixed to the CF substrate 11 in a desired manner and that can prevent a leakage of the liquid crystal layer 13 for a long period of time. Materials that are generally used for a sealing portion of a liquid crystal panel, such as a thermal curable resin material or a photocurable resin material, can be employed for this sealant without special limitations. It is preferable to use a photocurable resin material. Typically, the sealant is made of an ultraviolet curable resin material. A typical photocurable resin material is made of monomers (reactive diluent), oligomers (base resin), a photoinitiator, and additives (as necessary). When this material is irradiated with light (ultraviolet light, for example), photopolymerization is initiated by the photoinitiator, and then copolymerization, crosslinking, and the like between the oligomers or between the oligomer and the monomer occur. This causes the oligomers to be polymerized and cured, and as a result, the sealing portion 16 is formed. As the photocurable resin material, materials that include monomers and oligomers such as acrylic derivative, maleimide, and epoxy can be used, for example.

In the non-display region 10B, a black matrix installation area 30 is formed so as to enclose the display region 10A. The black matrix installation area 30 includes a black matrix forming section 32 where the frame black matrix 24 is formed, and a black matrix non-forming section 34 where the frame black matrix 24 is not formed. The black matrix non-forming section 34 is enclosed by the black matrix forming section 32. The frame black matrix 24 is formed in a frame shape that encloses the display region 10A so as to block external light (light leaking from the backlight device 70, for example) from entering the display region 10A. Typically, the frame black matrix 24 is formed in a continuous and unified manner with the black matrix 22 in the display region 10A, which borders the respective color filters 26. The black matrix forming section 32 where the frame black matrix 24 is formed includes a region (section) where the frame black matrix 24 is not formed. This region is the above-mentioned black matrix non-forming section 34. That is, the CF substrate 11 (to be exact, the transparent electrode 28 formed on the CF substrate 11) is exposed in the black matrix non-forming section 34 enclosed by the black matrix forming section 32. The sealing portion 16 is formed in the black matrix installation area 30 so as to be located in the black matrix non-forming section 34. This allows at least a part of the sealing portion 16 to make direct contact with the CF substrate 11. By making the sealing portion 16 directly in contact with the CF substrate 11, the adhesion of the sealing portion 16 can be improved as compared with the case where the sealing portion 16 makes contact with the frame black matrix 24, and therefore, the liquid crystal layer 13 can be sealed more effectively.

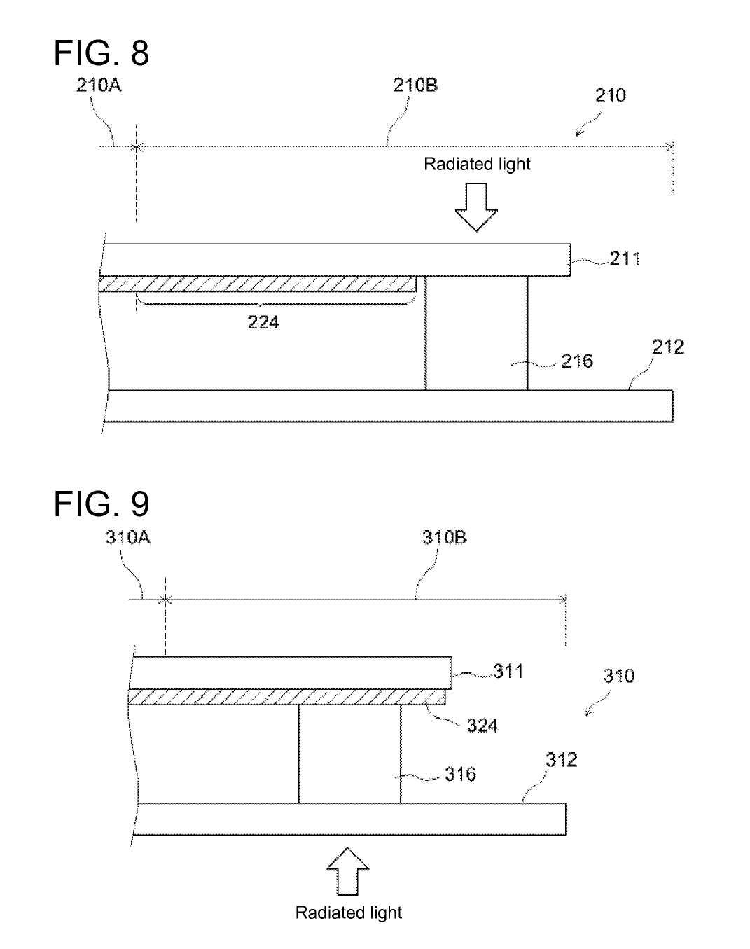

That is, in the liquid crystal panel 10 disclosed herein, an area of the non-display region 210B can be reduced significantly as compared with the conventional liquid crystal panel 210 in which the sealing portion 216 is disposed outside of the region where the frame black matrix 224 is formed, as shown in FIG. 8, for example, and thus a narrower frame can be achieved.

In the liquid crystal panel 10 having the sealing portion 16 disposed in the black matrix installation area 30, a light-shielding member 52 is provided on a surface of the CF substrate 11 on the side opposite to the side facing the array substrate 12. This light-shielding member 52 is provided in a section of the opposite side surface, which corresponds to the black matrix non-forming section 34, so as to cover the black matrix non-forming section 34 and so as to overlap the frame black matrix 24 on both sides of the black matrix non-forming section 34 through the CF substrate 11 interposed therebetween. The light-shielding member 52 is made of a material that can block any external light from entering the display region 10A regardless of the degree of polarization of the light. As the light-shielding member 52 made of such a material, a film or a tape made of a resin that includes a light-shielding material can be preferably used. It is preferable to use a film (or a tape) made of a material obtained by mixing carbon black into polyolefin such as polyethylene, polyester, or the like, or a laminated film (sheet) made by sandwiching a film (sheet) made of a light-shielding material (non-carbon material, for example) with polyolefin films (sheets), or the like, for example.

Because the light-shielding member 52 can block any light regardless of the degree of polarization, the technology disclosed herein can be employed for both the normally black type liquid crystal panel and the normally white type liquid crystal panel. In particular, the liquid crystal panel 10 disclosed herein can be suitably used for the normally white type liquid crystal panel that is configured such that light from a light source of a backlight device passes through the liquid crystal panel when no voltage is applied to the panel, and upon voltage application, light transmittance is improved in accordance with the voltage value, thereby controlling the transmission of light. In contrast, in a liquid crystal panel where the black matrix non-forming section 34 is covered with a polarizing sheet (polarizing plate), for example, external light can enter through the polarizing plate when no voltage is applied, and therefore, it is difficult to achieve the normally white type liquid crystal panel by using such a liquid crystal panel.

When a light-shielding film or tape is used as the light-shielding member 52, it becomes easier to completely cover the black matrix non-forming section 34 with the light-shielding member 52 with the CF substrate 11 interposed therebetween, thereby preventing a light leakage. In the non-display region 10B of the liquid crystal panel 10 having such a light-shielding member 52, the frame black matrix 24 is formed in the black matrix forming section 32 of the CF substrate 11. This makes it possible to prevent the external light from entering the display region 10A. Also, in the liquid crystal panel 10, external light that could enter the display region 10A through the black matrix non-forming section 34 can be appropriately blocked by the light-shielding member 52 that is provided on the surface of the CF substrate 11 on the side opposite to the side facing the array substrate 12.

As shown in FIG. 5, the black matrix non-forming section 34 formed as a part of the black matrix forming section 32 in the black matrix installation area 30 is preferably formed in a form of a slit 34A having a prescribed width. The width of the slit 34A can be set to any width as long as it allows the sealing portion 16 to be directly in contact with (affixed to) the CF substrate 11 with a high adhesion strength. When the black matrix non-forming section 34 is formed as the slit 34A, an area of the light-shielding member 52 that is disposed to cover the black matrix non-forming section 34 (the area of a region in which the light-shielding member 52 is adhered) can be minimized, and therefore, the amount used of the light-shielding member can be reduced. If the slit width of the slit 34A is smaller than the width of the sealing portion 16 (that is, a length in a direction along the slit width), as shown in FIG. 5, the sealing portion 16 may be configured such that a portion thereof makes direct contact with the CF substrate 11 in a groove portion (the black matrix non-forming section 34) of the slit 34A, and the rest of the sealing portion 16 makes contact with the frame black matrix 24 on both sides of the slit 34A.

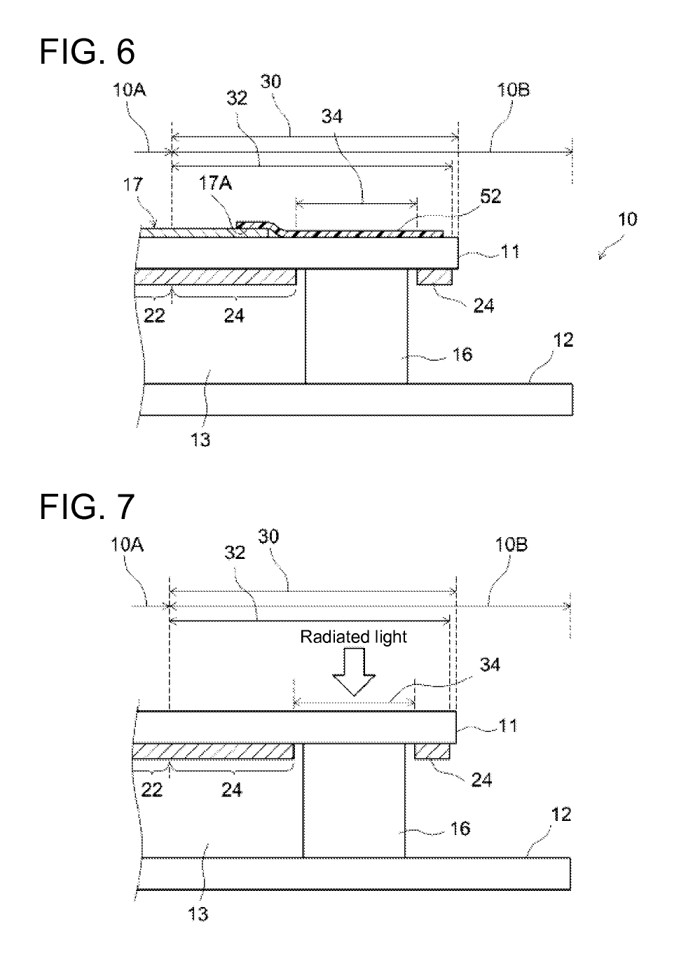

As shown in FIG. 6, in the liquid crystal panel 10, the polarizing sheet 17 is typically provided on the surface of the CF substrate 11 on the side opposite to the side facing the array substrate 12 (that is, a surface that corresponds to the front surface side when the liquid crystal panel 10 is installed in the liquid crystal display device 100). The polarizing sheet 17 is disposed such that the center portion thereof covers the display region 10A of the liquid crystal panel 10, and such that the peripheral portion 17A thereof covers at least a part of the non-display region 10B of the liquid crystal panel 10. When the liquid crystal panel 10 has the polarizing sheet 17 as described above, it is preferable to dispose the light-shielding member 52 that covers the black matrix non-forming section 34 such that at least a portion (typically, a peripheral edge) of the light-shielding member 52 overlaps the peripheral portion 17A of the polarizing sheet 17. The light-shielding member 52 also preferably overlaps the frame black matrix 24 on both sides of the black matrix non-forming section 34 through the CF substrate 11 interposed therebetween. By arranging the light-shielding member 52 in this manner, the light-shielding member 52 and the polarizing sheet 17 can overlap with no space therebetween, and the light-shielding member 52 and the frame black matrix 24 can overlap through the CF substrate 11 interposed therebetween. This makes it possible to effectively prevent external light from entering the display region 10A from the non-display region 10B.

In the liquid crystal display device 100 including the above-mentioned liquid crystal panel 10, the bezel 82 is placed on the front side of the liquid crystal panel 10 as shown in FIG. 1. A frame 84 is placed on the rear side of the liquid crystal panel 10. The bezel 82 and the frame 84 support the liquid crystal panel 10 by holding both surfaces thereof. Further, the frame 84 has an opening in a portion corresponding to the display region 10A of the liquid crystal panel 10. On the rear side of the liquid crystal panel 10, the backlight device 70 housed in a case 74 is provided.

As shown in FIG. 1, the backlight device 70 includes a plurality of linear light sources (such as fluorescent tubes, typically cold-cathode fluorescent lamps) 72 and the case (chassis) 74 that houses the light sources 72. The case 74 has a box shape that has an opening on the front side. In the case 74, the light sources 72 are typically arranged in parallel with each other, and between the case 74 and the light sources 72, a reflective member 76 is provided so as to efficiently reflect light from the light sources 72 toward the viewer's side.

In the opening of the case 74, a plurality of sheet-shaped optical members 78 are laminated so as to cover the opening. The optical members 78 include a diffusion plate, a diffusion sheet, a lens sheet, and a brightness enhancement sheet that are laminated in this order from the side close to the backlight device 70, for example. However, the configuration of the optical members 78 is not limited to this combination or this order. Further, the substantially frame-shaped frame 84 described above is provided on the case 74 so as to hold the optical members 78 by sandwiching them with the case 74.

On the rear side of the case 74, a not-shown inverter circuit board for mounting an inverter circuit, and a not-shown inverter transformer as a booster circuit that supplies power to the respective light sources 72 are provided. However, because the present invention is not defined by them, the explanations thereof are omitted.

Next, with reference to FIGS. 3, 4, and 7, an example of a method for manufacturing the liquid crystal panel 10 according to this embodiment will be explained.

A method for preparing the array substrate 12 by forming an array of TFTs on a glass substrate may be similar to a conventional method, and the photolithography can be employed as one of preferred methods. In this method, first, a metal film that forms not-shown gate lines (gate electrodes) is formed on a surface of a glass substrate 41, and a photosensitive agent (resist) is applied thereon. Next, on the resist, a mask having a pattern of an electronic circuit is placed (mask placement), and thereafter, an exposure process is performed by radiating light (typically ultraviolet light) from above. After the exposure process, the substrate is developed, and is etched along a pattern formed by the development, thereby forming the gate electrodes. The source lines 42, the transparent pixel electrodes 46, the planarizing layer 47, and the like, which are formed over this gate electrodes, are formed (laminated) sequentially on the gate electrodes by repeating the method similar to that for the gate electrodes.

Next, the alignment film 49 is formed by applying a material for forming an alignment film (polyimide material, for example) on the planarizing layer 47 by the inkjet method, for example, and by performing a rubbing process for controlling the orientation of the liquid crystal molecules (a process of rubbing the film with a cloth along a prescribed direction, for example). The array substrate (TFT substrate) 12 is prepared in this manner.

A method for preparing the CF substrate 11 of this embodiment may also be similar to a conventional method, and the photolithography can be employed as a preferred method in a manner similar to the array substrate 12. In this method, first, the black matrix 22 that borders the color filters 26 of the respective colors is formed in a grid pattern on a glass substrate by the photolithography. When the black matrix 22 is printed (formed), the frame black matrix 24 is also printed in the black matrix installation area 30 (that is, in a section that becomes the black matrix forming section 32) enclosed by the non-display region 10B at the same time, so that the two black matrices 22 and 24 are formed in a unified and continuous manner. Thereafter, by using a prescribed method, the black matrix non-forming section 34 is formed (as a slit having a prescribed width, for example) in a section enclosed by the frame black matrix 24.

Next, an R (red) pigment-dispersed resist (a resist material that can be obtained by dispersing a red pigment in a transparent resin), for example, is uniformly applied on the glass substrate in the display region 10A where the black matrix 22 is formed, and after placing a mask, an exposure process is conducted so as to print a pattern of R color filters. Next, by performing a development process, R sub-pixels (color filters) are formed in a prescribed pattern. G (green) and B (blue) color filters are formed in a manner similar to above. Thereafter, the planarizing layer 27 and a conductive film that becomes the transparent electrode 28 are formed on the color filters 26 and the black matrix 22 by sputtering, photolithography, or the like, for example.

The alignment film 29 may be formed on the transparent electrode 28 by employing a method similar to the method of forming the alignment film 49 on the array substrate 12. The CF substrate 11 is prepared in this manner.

Next, the array substrate 12 and the CF substrate 11 are bonded together. That is, first, in the black matrix installation area 30 of the CF substrate 11, a sealant (a sealing adhesive made of a thermal curable resin material or a photocurable resin material, for example) is provided. It is preferable to use a sealant made of a photocurable resin material because it makes it easier to form the sealing portion 16 in a manner described below. Below, a method of forming the sealing portion 16 by using the sealant made of the photocurable resin material will be explained as an example. A sealant made of such a material is provided (applied) in a section that includes the black matrix non-forming section 34 so that the sealant makes direct contact with the CF substrate 11 in the black matrix non-forming section 34.

Next, the spacers 19 are disposed (sprayed) on the CF substrate 11 so as to create space (gap) between the array substrate 12 and the CF substrate 11. Thereafter, the array substrate 12 is placed over the CF substrate 11 such that the surfaces thereof that respectively have the alignment films 29 and 49 face each other.

Next, in order to bond the stacked two substrates 11 and 12, the sealant is cured, thereby forming the sealing portion 16. That is, as shown in FIG. 7, first, in the stacked two substrates 11 and 12, light (ultraviolet light, for example) for curing the sealant is radiated from the surface of the CF substrate 11 on the side opposite to the side facing the array substrate 12. Upon radiation, the incident light preferably passes through the black matrix non-forming section 34, and enters a space between the two substrates 11 and 12. When the light is radiated in this manner, the sealant, which is in direct contact with the CF substrate 11 in the black matrix non-forming section 34, can absorb the radiated light efficiently, resulting in the sealing portion 16 that is cured in the desired manner.

In the liquid crystal panel 310 having a conventional configuration as shown in FIG. 9, for example, a sealant is in contact with the frame black matrix 324 that has a low light transmittance, and therefore, in order to form the sealing portion 316 by curing the sealant, it is necessary to radiate light from the side of the array substrate 312. This creates a need to provide a slit in not-shown metal wiring lines that are formed in the array substrate 312 so that the radiated light can reach the sealant through the slit, and this makes it difficult to form the sealing portion 316. Also, because the sealant cannot be irradiated uniformly, the sealant may not be cured properly.

In contrast, the liquid crystal panel 10 disclosed herein has the black matrix non-forming section 34 in the black matrix installation area 30, which allows the sealing portion 16 to be properly cured and bonded to the CF substrate 11 (and the array substrate 12) with ease, and as a result, the two substrates 11 and 12 can be firmly bonded. When a thermal curable resin material is used as the sealant, the sealing portion 16 can be formed by heating a section where the sealant is applied with a prescribed method.

Next, the pair of substrates 11 and 12 that have been bonded is placed in a vacuum chamber, and a liquid crystal material is injected into a space (gap) between the substrates through the capillary action. After the gap is filled with the liquid crystal material, the injection hole is sealed. Lastly, the polarizing sheets 17 and 18 are bonded to the respective surfaces of the substrates 11 and 12 on the sides not facing each other.

Next, the light-shielding member 52 is provided on a surface of the CF substrate 11 on the side having the polarizing sheet 17. It is preferable that the light-shielding member 52 be made of a material that can block any light regardless of the degree of polarization (a resin material, for example) as described above. The light-shielding member 52 is also preferably a tape-shaped or film-shaped member. The light-shielding member 52 is placed (bonded) so as to overlap the frame black matrix 24 through the CF substrate 11 interposed therebetween. By arranging the light-shielding member 52 in this manner, in the non-display region 10B of the liquid crystal panel 10, a gap and the like that could allow external light to enter is effectively eliminated by the frame black matrix 24 and the light-shielding member 52, thereby making it possible to appropriately block external light from entering the display region 10A.

The liquid crystal panel 10 is completed in this manner.

The bezel 82 and the frame 84 are respectively provided on the front side (that is, the side of the CF substrate 11) and the rear side (the side of the array substrate 12) of the liquid crystal panel 10 fabricated as described above so as to hold the liquid crystal panel 10. Thereafter, the optical members 78 and the backlight device 70 housed in the case 74 are provided on the rear side of the frame 84. The liquid crystal display device 100 is constructed as described in this manner.

The present invention has been described with the preferred embodiment above, however, the present invention is not limited to such a description, and it is apparent that various modifications may be made.

### INDUSTRIAL APPLICABILITY

According to the liquid crystal panel provided by the present invention, because the sealing portion is arranged in the black matrix installation area, it becomes possible to make the non-display region smaller, thereby achieving a narrower frame. By forming the black matrix non-forming section enclosed by a black matrix forming section, an adhesion between the sealing portion and a CF substrate in the black matrix non-forming section can be improved, allowing the sealing portion to securely seal the liquid crystal layer for a long period of time. The black matrix non-forming section is covered by the light-shielding member that can block any light regardless of the degree of polarization, and therefore, it becomes possible to prevent light from entering the display region. Further, when forming the sealing portion from a sealant made of a photocurable resin material in particular, a properly cured sealing portion can be formed with ease by radiating light from the side of the CF substrate such that the light passes through the black matrix non-forming section.

Thus, by employing such a liquid crystal panel, it becomes possible to provide a high-durability liquid crystal display device that can achieve both a narrower frame and an excellent display quality at a high level with ease.

### DESCRIPTION OF REFERENCE CHARACTERS

10 liquid crystal panel
10A display region
10B non-display region
11 color filter substrate (CF substrate)
12 array substrate
13 liquid crystal layer
14 flexible board
15 connecting board
16 sealing portion
17, 18 polarizing sheet (polarizing plate)
19 spacer
21 glass substrate
22 black matrix
24 frame black matrix
26 color filter
27 planarizing layer
28 transparent electrode
29 alignment film
30 black matrix installation area
32 black matrix forming section
34 black matrix non-forming section
34A slit
41 glass substrate
42 source line
46 pixel electrode
47 planarizing layer
49 alignment film
52 light-shielding member
70 backlight device
72 light source
74 case (chassis)
76 reflective member
78 optical member
82 bezel
84 frame
100 liquid crystal display device

1. A liquid crystal panel, comprising:
first and second substrates facing each other;
a liquid crystal layer disposed between the two substrates; and
a sealing portion formed between the substrates in a peripheral portion so as to enclose the liquid crystal layer, the sealing portion holding the liquid crystal layer between the two substrates;
wherein the sealing portion is provided on a surface of the first substrate on a side facing the second substrate in a non-display region such that at least a part thereof makes direct contact with the first substrate, and the non-display region is formed in an outer peripheral portion of a display region,
wherein the non-display region has a black matrix installation area that includes a black matrix forming section and a black matrix non-forming section, the black matrix forming section has therein a black matrix that blocks external light from entering the display region, and the black matrix non-forming section is without the black matrix and is enclosed by the black matrix forming section,
wherein the sealing portion is formed in the black matrix installation area such that at least a portion of the part thereof in direct contact with the first substrate is located in the black matrix non-forming section, and
wherein the first substrate has a light-shielding member disposed on a surface thereof on a side opposite to the surface facing the second substrate, the light-shielding member is formed in a section that corresponds to the black matrix non-forming section so as to partially overlap the black matrix through the first substrate interposed therebetween, and the light-shielding member is made of a material that can block the external light regardless of a degree of polarization of the external light.

2. The liquid crystal panel according to claim 1, wherein the sealing portion is made of a photocurable resin material.

3. The liquid crystal panel according to claim 1, wherein the light-shielding member is bonded to the surface of first substrate in a tape shape or a film shape.

4. The liquid crystal panel according to claim 1, wherein the black matrix non-forming section is formed as a slit having a prescribed width.

5. The liquid crystal panel according to claim 1, further comprising a polarizing sheet formed on the surface of the first substrate on the side opposite to the surface facing the second substrate, the polarizing sheet being arranged such that a center portion thereof covers the display region and such that a peripheral portion thereof overlaps at least a part of the non-display region,
wherein the light-shielding member is arranged such that at least a part thereof overlap the peripheral portion of the polarizing sheet.

6. A method for manufacturing a liquid crystal panel that includes a pair of substrates facing each other, a liquid crystal layer disposed between the pair of substrates, and a sealing portion between the pair of substrates in a peripheral portion so as to enclose the liquid crystal layer, the sealing portion holding the liquid crystal layer between the pair of substrates, the method comprising:
preparing first and second substrates that constitute the pair of substrates, the first substrate having a black matrix installation area that includes a black matrix forming section and a black matrix non-forming section on one surface in a non-display region formed in an outer peripheral portion of a display region, the black matrix forming section having therein a black matrix that blocks external light from entering the display region, the black matrix non-forming section being without the black matrix and being enclosed by the black matrix forming section;
applying a sealant for forming the sealing portion such that at least a part thereof makes direct contact with the first substrate, the sealant being provided in the black matrix installation area such that at least a portion of the part thereof in direct contact with the first substrate is located in the black matrix non-forming section;
assembling the first substrate and the second substrate with the sealant interposed therebetween such that a surface of the first substrate where the black matrix is formed faces the second substrate;
curing the sealant to form the sealing portion to bond the first substrate and the second substrate through the sealing portion; and
disposing a light-shielding member on the surface of the first substrate on the side opposite to the surface facing the second substrate in a section that corresponds to the black matrix non-forming section, such that a part of the light-shielding member overlaps the black matrix through the first substrate interposed therebetween, the light-shielding member being made of a material that can block the external light regardless of a degree of polarization of the external light.

7. The manufacturing method according to claim 6, wherein the sealant is made of a photocurable resin material, and the sealant is cured by light that is radiated from the side of the first substrate opposite to the side facing the second substrate and that passes through the black matrix non-forming section.

8. The manufacturing method according to claim 6, wherein the light-shielding member is a tape-shaped or film-shaped light-shielding member, and the light-shielding member is affixed to the surface of the first substrate on the side opposite to the side facing the second substrate.

9. The manufacturing method according to claim 6, wherein the first substrate includes a slit having a prescribed width as the black matrix non-forming section.

10. The manufacturing method according to claim 6, further comprising placing a polarizing sheet on the surface of the first substrate on the side opposite to the side facing the second substrate such that a center portion thereof covers the display region and such that a peripheral portion thereof overlaps a part of the non-display region,
wherein, after the polarizing sheet is provided, the light-shielding member is formed such that at least a part of the light-shielding member overlaps the peripheral portion of the polarizing sheet.

11. A liquid crystal display device, comprising the liquid crystal panel according to claim 1.

12. A liquid crystal display device, comprising the liquid crystal panel manufactured by the method according to claim 6.
